(19) United States
(12) Patent Application Publication
(10) Pub. No.: US 2012/0009392 A1
(43) Pub. Date: Jan. 12, 2012

(54) Strengthened substrate structure

(76) Inventors: SHIH-LIANG CHOU, Tao-Yuan (TW); Chien-Min Weng, Tao-Yuan (TW); Hsueh-Chih Chiang, Tao-Yuan (TW); I-Wen Lee, Tao-Yuan (TW); Hsing-Yeh Chen, Tao-Yuan (TW)

(21) Appl. No.: 12/832,741

(22) Filed: Jul. 8, 2010

(51) Int. Cl. G02B 1/00; B32B 3/02

(52) U.S. Cl. 428/192; 428/411.1

(57) ABSTRACT

The substrate according to the invention includes at least one surface coated with an organic buffer layer and the organic buffer layer is provided with a coating layer on a surface thereof opposite to its surface attached to the substrate. The provision of the organic buffer layer diminishes the effect of the coating layer on the strength of the substrate, thereby maintaining the strength of the substrate.

### BACKGROUND OF THE INVENTION

1. Field of the Invention

The present invention relates to a strengthened substrate structure and, more particularly, to a strengthened substrate structure for use in optical lenses or ordinary optoelectronic products.

2. Description of the Prior Art

The lenses of eyeglasses for ordinary or leisure activities are typically made of glass or plastic resin materials and are suitable for either non-corrective uses or corrective purposes for alleviating the conditions of myopia or hyperopia, depending on the concave-convex geometry and curvature of lens surfaces. Some lenses are coated with optical coatings to provide protection against damage from ultraviolet light. Despite so, the purposes for which the eyeglasses are designed are mostly directed to providing vision correction to patients who suffer from myopia or presbyopia or providing eye protection against sunlight and other environmental damages and, therefore, the structural strength and the safety of the eyeglasses have to meet modern regulations. That is to say, the eyeglasses should stand up to the scrutiny of the American National Standards Institute (ANSI) by passing the so-called High Mass Impact test, the High Velocity Impact test and the Drop Ball Test, so as to ensure that they can tolerate impact from outside forces coming at various angles.

In addition, since indium tin oxide (ITO) transparent substrates have advantages of high optical transparency, electrical conductivity and uniformity, they have been adopted in a broad variety of optoelectronic products, such as liquid crystal display panels, touch panels, organic electroluminescent display panels, plasma display panels, automobile heat-resistant anti-fogging windshields, solar cells, photoelectric converters, anti-static films of transparent heaters and infrared reflection devices. Given that the quality of ITO transparent substrates will profoundly affect the productivity of the optoelectronic products described above, it becomes a critical factor to the improvement of the products and is considered by the manufacturers as a very serious issue.

The lenses and the optoelectronic products described above are all configured to have a basic coating layer structure, in which the substrate may be chemically tempered. However, the application of the coating onto the substrate may directly interfere with the property of the substrate and result in a reduced strength (as measured by the Drop Ball Test, for example). Therefore, there exists a need in the art for a substrate with improved strength and impact resistant property. The present invention provides the best solution in response to the need.

### SUMMARY OF THE INVENTION

The substrate according to the invention includes at least one surface coated with an organic buffer layer, wherein the organic buffer layer is provided with a coating layer on a surface thereof opposite to its surface attached to the substrate. The substrate according to the invention is suitable for being used in optical lenses and ordinary optoelectronic products, such as liquid crystal display panels, touch panels, organic electroluminescent display panels, plasma display panels, automobile heat-resistant anti-fogging windshields, solar cells, photoelectric converters, anti-static films of transparent heaters and infrared reflection devices. It is believed that the provision of the organic buffer layer diminishes the effect of the coating layer on the substrate strength, thereby maintaining the strength and impact resistant property of the substrate.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a structural schematic diagram illustrating a substrate according to the first preferred embodiment of the invention;

FIG. 2 is a perspective schematic diagram illustrating a substrate according to the first preferred embodiment of the invention;

FIG. 3 is a structural schematic diagram illustrating a substrate according to the second preferred embodiment of the invention; and

FIG. 4 is an exploded diagram of a substrate according to the third preferred embodiment of the invention.

### DETAILED DESCRIPTION OF THE PREFERRED EMBODIMENTS

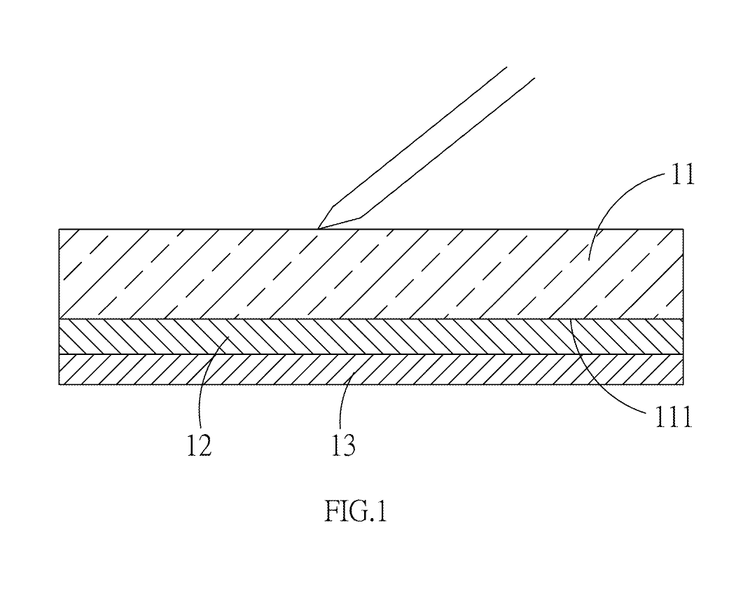

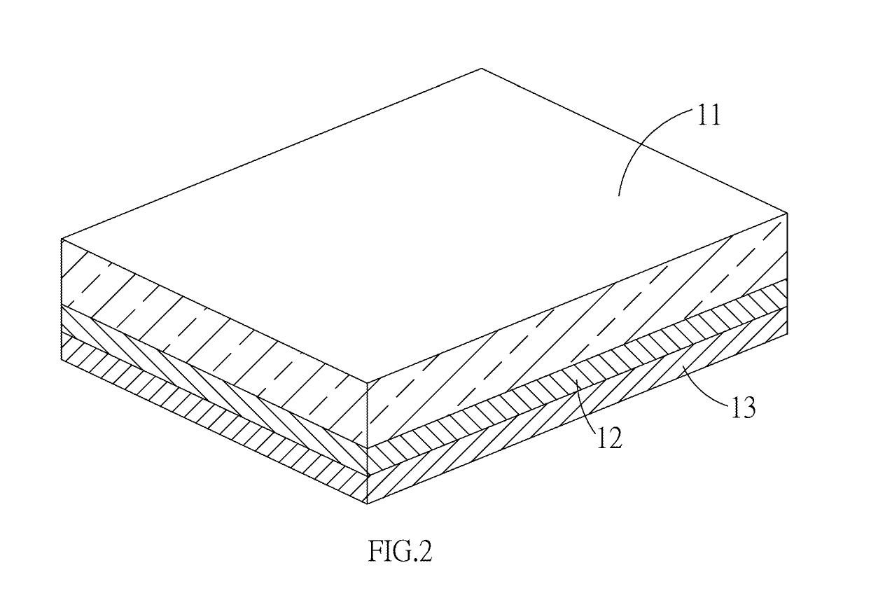

The present invention relates to a strengthened substrate structure. As shown in FIGS. 1 and 2, a substrate 11 according to the invention includes at least one surface 111 provided with an organic buffer layer 12. The organic buffer layer 12 may by way of example be photoresist or ink materials. A coating layer 13 is disposed on the opposite surface of the organic buffer layer 12 to the surface thereof attached to the substrate 11. The coating layer 13 may by way of example be an optical oxide film. According to the embodiment illustrated in FIGS. 1 and 2, the organic buffer layer 12 covers the entire surface 111 of the substrate 11. The substrate according to the invention is a transparent substrate adapted for being used in optical lenses and ordinary optoelectronic products, such as liquid crystal display panels, touch panels, organic electroluminescent display panels, plasma display panels, automobile heat-resistant anti-fogging windshields, solar cells, photoelectric converters, anti-static films of transparent heaters and infrared reflection devices.

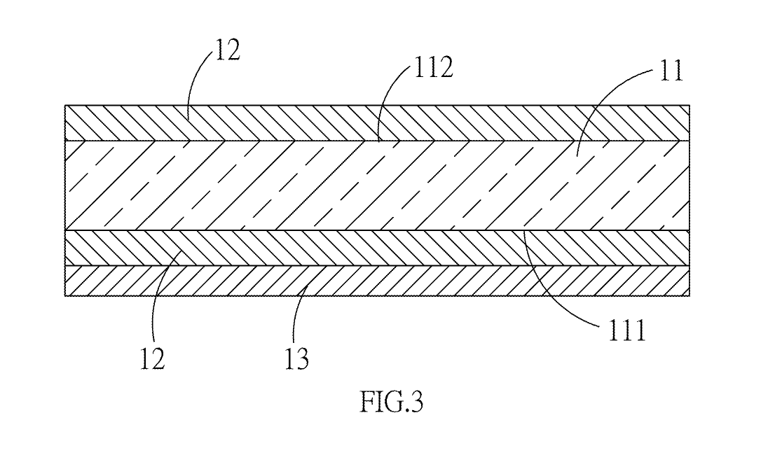

According to the second embodiment shown in FIG. 3, the two opposite surfaces 111, 112 of the substrate 11 are both coated with organic buffer layers 12, while a coating layer 13 is disposed on one of the two organic buffer layers 12.

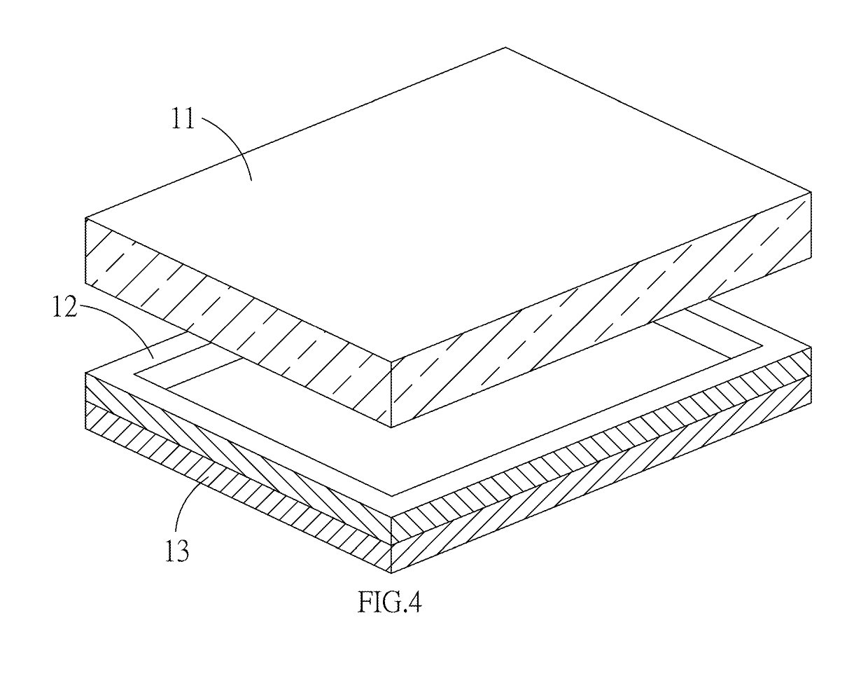

According to the third embodiment shown in FIG. 4, the inventive substrate is employed in a touch panel. In this case, the substrate 11 is a transparent substrate and an organic buffer layer 12 is coated in a peripheral region of a surface of the transparent substrate 11. The coating layer 13 may by way of example be an ITO transparent conductive coating layer formed by sputtering at a low temperature of less than 200° C. The coating layer 13 is superimposed on the organic buffer layer 12 and the portion of the substrate 11 which is surrounded by the peripheral region and not covered by the organic buffer layer 12.

It should be noted that the substrate according to the invention is first coated on a surface thereof with an organic buffer layer and then sputtered with a coating layer on top of the organic buffer layer. Owing to the organic buffer layer, the influence of the coating layer on the strength of the substrate is reduced, so that the strength and impact resistant property of the substrate are maintained.

Two different substrates are subjected to the Drop Ball Test in accordance with the ANSI specifications. In the test, a steel ball with a specific dimension is dropped from a certain height to impact a surface of the object for testing. The conditions of the tested objects are evaluated to determine the impact resistant property. A substrate of Comparative Example 1 and an inventive substrate (Example 2), each having a dimension of 82.95×45 mm and a thickness of 0.7 mm, are impacted by a steel ball of 130 grams in weight. The results so obtained are shown in Table 1 below.

TABLE 1

| | Comparative Example 1 | | Example 2 | |
|---|---|---|---|---|
| | surface | surface | surface | surface |
| | with | without | with | without |
| | sputtering | sputtering | sputtering | sputtering |
| maximum | 60 | 40 | 70 | 50 |
| height | | | | |
| (cm) | | | | |
| minimum | 30 | 15 | 40 | 30 |
| height | | | | |
| (cm) | | | | |
| Average | 45 | 27.5 | 55 | 40 |
| height | | | | |
| (cm) | | | | |

The Comparative Example 1 is directed to a chemically tempered substrate provided on a surface thereof with a sputtering layer alone, whereas the Example 2 is directed to the chemically tempered substrate according to the invention which is first coated on a surface thereof with an organic buffer layer and then sputtered with a layer on top of the organic buffer layer. It can be seen from the test results that the surface with sputtering and the surface without sputtering of Example 2 (the inventive substrate) are both capable of tolerating ball impact from greater heights as compared to the counterpart surfaces of the substrate of Comparative Example 1, indicating that Example 2 (the inventive substrate) has superior strength and impact resistant property over Comparative Example 1.

In conclusion, the strengthened substrate structure as disclosed herein can surely achieve the intended objects and effects of the invention. While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit of the invention and the scope thereof as defined in the appended claims.

What is claimed is:

1. A strengthened substrate structure, comprising a substrate having two opposite surfaces, wherein at least one of the two opposite surfaces is coated with an organic buffer layer, and wherein the organic buffer layer is provided with a coating layer on a surface thereof opposite to its surface attached to the substrate.

2. The strengthened substrate structure according to claim 1, wherein the respective opposite surfaces of the substrate are coated with an organic buffer layer and the coating layer is disposed on one of the two organic buffer layers.

3. The strengthened substrate structure according to claim 1, wherein the organic buffer layer entirely covers the at least one surface of the substrate.

4. The strengthened substrate structure according to claim 1, wherein the organic buffer layer covers only a peripheral region of the at least one surface of the substrate.

5. The strengthened substrate structure according to claim 1, wherein the substrate is a transparent substrate and the organic buffer layer is coated in a peripheral region of the at least one surface of the transparent substrate, and wherein the coating layer is an optical oxide film or an ITO transparent conductive coating layer superimposed on the organic buffer layer and a portion of the substrate which is surrounded by the peripheral region and not covered by the organic buffer layer.

6. The strengthened substrate structure according to claim 5, wherein the coating layer is formed by sputtering at a low temperature of less than 200° C.

7. The strengthened substrate structure according to claim 5, wherein the organic buffer layer is photoresist or ink materials.

8. The strengthened substrate structure according to claim 1, wherein the organic buffer layer is photoresist or ink materials.

9. A strengthened substrate structure, comprising a transparent substrate having two opposite surfaces, wherein at least one of the two opposite surfaces is coated with an organic buffer layer and the organic buffer layer is coated in a peripheral region of the at least one surface of the transparent substrate, and wherein the organic buffer layer is provided with a coating layer on a surface thereof opposite to its surface attached to the substrate and the coating layer is an optical oxide film or an ITO transparent conductive coating layer superimposed on the organic buffer layer and a portion of the transparent substrate which is surrounded by the peripheral region and not covered by the organic buffer layer.

10. The strengthened substrate structure according to claim 9, wherein the organic buffer layer is photoresist or ink materials.

11. The strengthened substrate structure according to claim 9, wherein the coating layer is formed by sputtering at a low temperature of less than 200° C.
